(19) United States
(12) Patent Application Publication
(10) Pub. No.: US 2009/0225468 A1
(43) Pub. Date: Sep. 10, 2009

(54) MAGAZINE ACCESS RESTRICTION WITH DEEP SLOT TECHNOLOGY

(75) Inventors: BRIAN G. GOODMAN, Tucson, AZ (US); Aaron L. Herring, Tucson, AZ (US)

Correspondence Address: HAMILTON & TERRILE, LLP;IBM Tucson, P.O. BOX 203518, AUSTIN, TX, 78720, US

(73) Assignee: International Business Machines Corporation, Armonk, NY (US)

(21) Appl. No.: 12/041,872

(22) Filed: Mar. 4, 2008

(51) Int. Cl. G11B 15/68

(52) U.S. Cl. 360/92.1

(57) ABSTRACT

A magazine includes a housing defining an interior space and an exterior space and a plurality of storage slots disposed within the housing. The magazine further includes at least one cartridge blocker that alternates between an open position and a closed position, wherein the open position provides access to at least one of the storage slots, and wherein the closed position substantially prevents access to at least one of the storage slots.

### FIELD OF INVENTION

The present invention generally relates to storage libraries. More specifically, the invention relates to storage libraries with removable magazines.

### BACKGROUND OF THE INVENTION

Automated data storage libraries are known for providing cost effective storage and retrieval of large quantities of data. The data in automated data storage libraries is stored on data storage media that are, in turn, stored on storage shelves or the like inside the library in a fashion that renders the media, and its resident data, accessible for physical retrieval. Such media is commonly termed “removable media.” Data storage media may comprise any type of media on which data may be stored and which may serve as removable media, including but not limited to magnetic media (such as magnetic tape or disks), optical media (such as optical tape or disks), electronic media (such as PROM, EEPROM, flash PROM, CompactFlash™, Smartmedia™, Memory Stick™, etc.), or other suitable media. Typically, the data stored in automated data storage libraries is resident on data storage media that is contained within a cartridge and referred to as a data storage media cartridge. An example of a data storage media cartridge that is widely employed in automated data storage libraries for mass data storage is a magnetic tape cartridge.

In addition to data storage media, automated data storage libraries typically contain data storage drives that store data to, and/or retrieve data from, the data storage media. The transport of data storage media between data storage shelves and data storage drives is typically accomplished by one or more robot accessors (hereinafter termed “accessors”). Such accessors have grippers for physically retrieving the selected data storage media from the storage shelves within the automated data storage library and transport such media to the data storage drives by moving in the X and Y directions.

In an effort to increase storage capacity, deep slot technology allows for storage slots that contain more than a single cartridge. Such storage libraries allow for higher density, or more cartridges stored per square foot. In ‘deep slot’ libraries, two or more cartridges are arrayed in series so that accessing desired cartridges may require removing cartridges stored in front of the desired cartridge.

Deep slot technology requires that there be enough free storage space, I/O space, gripper space, etc. to hold the number of cartridges that can be contained in a deep slot, minus one. This is because the library may have to access the last cartridge in a deep slot, and the cartridges in front of the last cartridge must be moved out of the way. For example, if a library has storage slots that can contain 5 cartridges, then the library will need to be able to place 4 of the 5 cartridges somewhere else, while it accesses the 5th cartridge with a library gripper.

One problem with deep slot technology is inventory. This is because, except for the first cartridge, a bar code reader cannot see the cartridge labels in a deep slot without removal. As a result, the library must remove each cartridge to read the label of the cartridge behind it, and to ensure that there are no more cartridges to read. This can be very time consuming, and an operator may be long gone after placing or replacing a magazine, closing a library door, or powering up a library. These problems are especially aggravated when a cartridge is placed into the library, either as a new cartridge, or a previously removed cartridge. Since each cartridge that is removed from the magazine must be placed somewhere while the inventory is performed, what is needed is a quick method of determining that the minimum required number of storage slots are available after a magazine has been placed in the library, after a library door has been closed, or after a library reset or power-on.

Another problem with deep slot technology is I/O station support. This is because a deep slot library attempts to maximize storage capacity and taking room for a dedicated I/O station can be costly. One of the deep slot magazines could be used for I/O. However, this could be costly in a small library where only one or two deep slot magazines may be present.

What is needed is a method of providing I/O station capability to a deep slot library without impacting library capacity and without a high I/O slot to storage slot ratio.

It is therefore a challenge to develop strategies for storing cartridges to overcome these, and other, disadvantages.

### SUMMARY OF THE INVENTION

One embodiment of the invention provides a magazine that includes a housing defining an interior space and an exterior space and a plurality of storage slots disposed within the housing. The magazine further includes at least one cartridge blocker that alternates between an open position and a closed position, wherein the open position provides access to at least one of the storage slots, and wherein the closed position substantially prevents access to at least one of the storage slots.

Another embodiment of the present invention is a tape library system. The system includes a library frame including at least one magazine. At least one of the at least one magazine includes a housing defining an interior space and an exterior space, a plurality of storage slots disposed within the housing, and at least one cartridge blocker. The cartridge blocker alternates between an open position and a closed position, wherein the open position provides access to at least one of the plurality of storage slots, and the closed position substantially prevents access to at least one of the plurality of storage slots. The cartridge blocker alternates between the open position and closed position responsive to actuation by a library frame member, and removal of the one of the at least one magazine from the library frame results in the library frame member translating the cartridge blocker from the open to the closed position, and placing the one of the at least one magazine in the library frame translates the cartridge blocker from the closed position to the open position.

Yet another embodiment of the invention provides a method for storing cartridges. The method includes removing a first magazine from a library frame, translating a cartridge blocker to a closed position based on the removal, and receiving the first magazine into the library frame. Additionally, the method includes translating a cartridge blocker to an open position based on the receiving of the first magazine.

The foregoing embodiment and other embodiments, objects, and aspects as well as features and advantages of the present invention will become further apparent from the following detailed description of various embodiments of the present invention. The detailed description and drawings are merely illustrative of the present invention, rather than limiting the scope of the present invention being defined by the appended claims and equivalents thereof.

### BRIEF DESCRIPTION OF THE DRAWINGS

FIG. 1 is an isometric view of an automated data storage library adaptable to implement an embodiment of the present invention, with the view specifically depicting a library having a left hand service bay, multiple storage frames and a right hand service bay;

FIG. 2 is an isometric view of an automated data storage library adaptable to implement an embodiment of the present invention, with the view specifically depicting an exemplary basic configuration of the internal components of a library;

FIG. 3 is a block diagram of an automated data storage library adaptable to implement an embodiment of the present invention, with the diagram specifically depicting a library that employs a distributed system of modules with a plurality of processor nodes;

FIG. 4 is a block diagram depicting an exemplary controller configuration;

FIG. 5 is an isometric view of the front and rear of a data storage drive canister adaptable to implement an embodiment of the present invention;

FIG. 6 is an isometric view of a data storage cartridge adaptable to implement an embodiment of the present invention;

FIGS. 7-10 illustrate one embodiment of a magazine in accordance with one aspect of the invention;

FIG. 11 illustrates one embodiment of a method for storing cartridges in accordance with one aspect of the invention; and

FIGS. 12-15 illustrate another embodiment of a magazine in accordance with one aspect of the invention.

### DETAILED DESCRIPTION OF THE PRESENT INVENTION

This invention is described in preferred embodiments in the following description with reference to the Figures, in which like numerals represent the same or similar elements. While this invention is described in terms of the best mode for achieving this invention's objectives, it will be appreciated by those skilled in the art that it is intended to cover alternatives, modifications, and equivalents as may be included within the spirit and scope of the invention as defined by the appended claims.

The invention will be described as embodied in an automated magnetic tape library storage system for use in a data processing environment. Although the invention shown uses magnetic tape cartridges, one skilled in the art will recognize the invention equally applies to optical disk cartridges or other removable storage media and the use of either different types of cartridges or cartridges of the same type having different characteristics. Furthermore the description of an automated magnetic tape storage system is not meant to limit the invention to magnetic tape data processing applications as the invention herein can be applied to any media storage and cartridge handling systems in general.

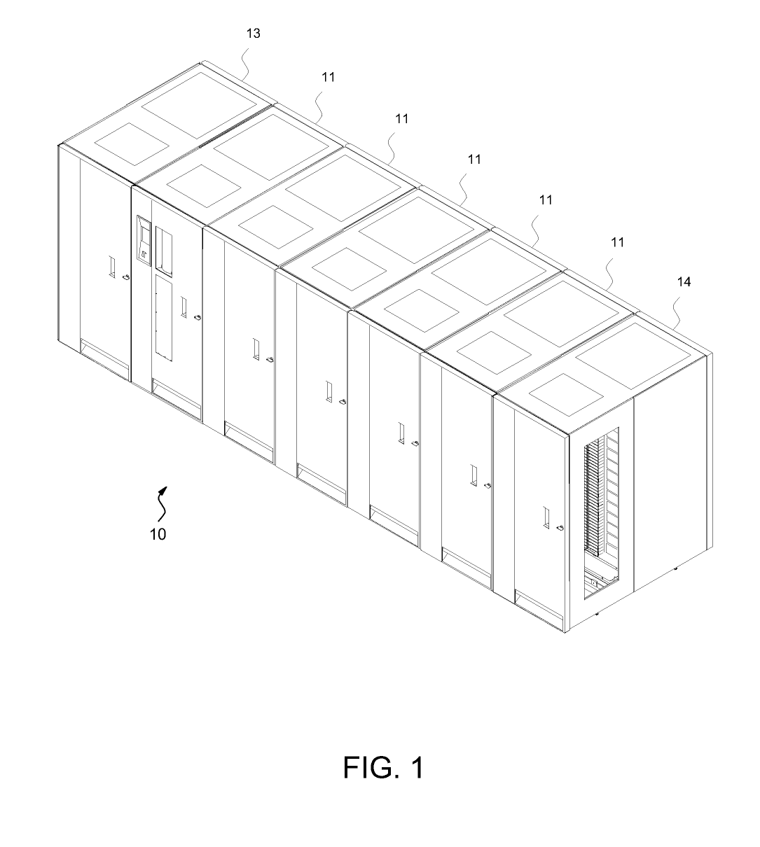

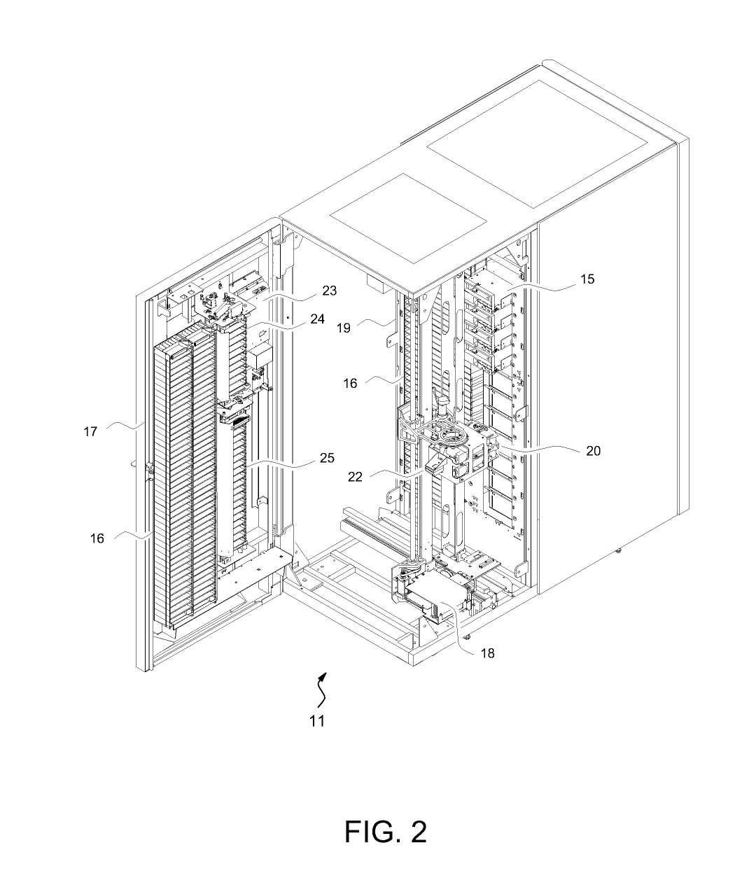

Turning now to the Figures, FIGS. 1 and 2 illustrate an automated data storage library 10 which stores and retrieves data storage cartridges containing data storage media (not shown) in storage shelves 16. It is noted that references to “data storage media” herein refer to data storage cartridges, and for purposes herein the two terms are used synonymously. An example of an automated data storage library which may implement the present invention, and has a configuration as depicted in FIGS. 1 and 2, is the IBM 3584 UltraScalable Tape Library. The library of FIG. 1 comprises a left hand service bay 13, one or more storage frames 11, and right hand service bay 14. As will be discussed, a frame may comprise an expansion component of the library. Frames may be added or removed to expand or reduce the size and/or functionality of the library. Frames may comprise additional storage shelves, drives, import/export stations, accessors, operator panels, etc.

FIG. 2 shows an example of a storage frame 11, which is the base frame of the library 10 and is contemplated to be the minimum configuration of the library. In this minimum configuration, there is only a single accessor (i.e., there are no redundant accessors) and there is no service bay. The library 10 is arranged for accessing data storage media in response to commands from at least one external host system (not shown), and comprises a plurality of storage shelves 16, on front wall 17 and rear wall 19 for storing data storage cartridges that contain data storage media; at least one data storage drive 15 for reading and/or writing data with respect to the data storage media; and a first accessor 18 for transporting the data storage media between the plurality of storage shelves 16 and the data storage drive(s) 15. The data storage drives 15 may be optical disk drives or magnetic tape drives, or other types of data storage drives as are used to read and/or write data with respect to the data storage media. The storage frame 11 may optionally comprise an operator panel 23 or other user interface, such as a web-based interface, which allows a user to interact with the library. The storage frame 11 may optionally comprise an upper I/O station 24 and/or a lower I/O station 25, which allows data storage media to be inserted into the library and/or removed from the library without disrupting library operation. The library 10 may comprise one or more storage frames 11, each having storage shelves 16 accessible by first accessor 18.

As described above, the storage frames 11 may be configured with different components depending upon the intended function. One configuration of storage frame 11 may comprise storage shelves 16, data storage drive(s) 15, and other optional components to store and retrieve data from the data storage cartridges. The first accessor 18 comprises a gripper assembly 20 for gripping one or more data storage media and may include a bar code scanner 22 or other reading system, such as a cartridge memory reader or similar system, mounted on the gripper 20, to “read” identifying information about the data storage media.

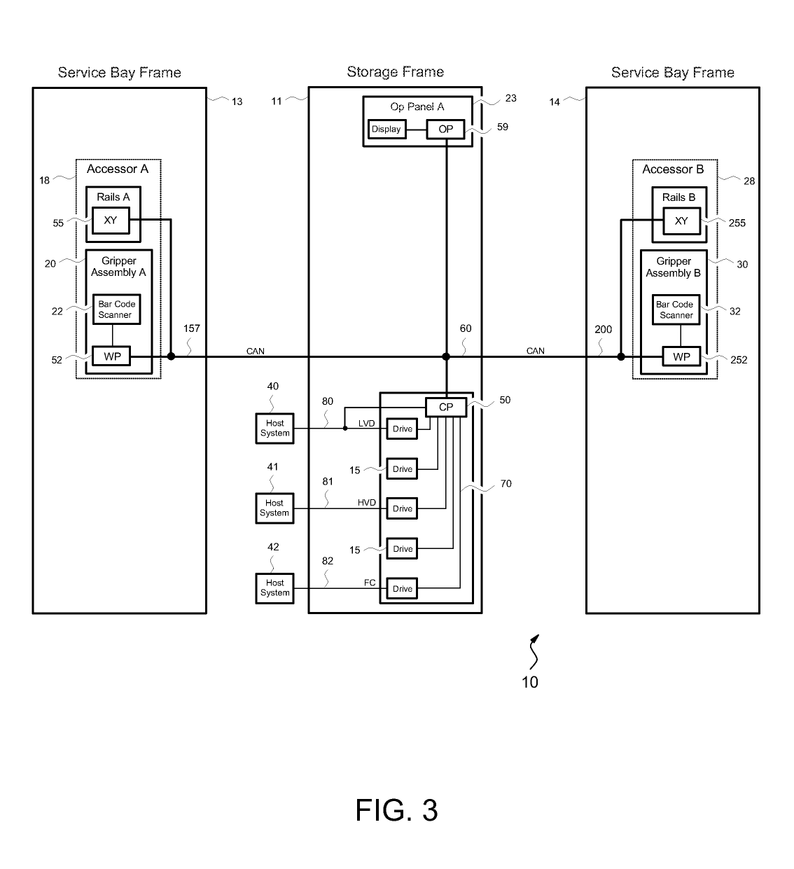

FIG. 3 illustrates an embodiment of an automated data storage library 10 of FIGS. 1 and 2, which employs a distributed system of modules with a plurality of processor nodes. An example of an automated data storage library which may implement the distributed system depicted in the block diagram of FIG. 3, and which implement the present invention, is the IBM 3584 UltraScalable Tape Library. For a fuller understanding of a distributed control system incorporated in an automated data storage library, refer to U.S. Pat. No. 6,356,803, which is entitled “Automated Data Storage Library Distributed Control System,” which is incorporated herein for reference.

While the automated data storage library 10 has been described as employing a distributed control system, the present invention may be implemented in automated data storage libraries regardless of control configuration, such as, but not limited to, an automated data storage library having one or more library controllers that are not distributed, as that term is defined in U.S. Pat. No. 6,356,803. The library of FIG. 3 comprises one or more storage frames 11, a left hand service bay 13 and a right hand service bay 14. The left hand service bay 13 is shown with a first accessor 18. As discussed above, the first accessor 18 comprises a gripper assembly 20 and may include a reading system 22 to “read” identifying information about the data storage media. The right hand service bay 14 is shown with a second accessor 28. The second accessor 28 comprises a gripper assembly 30 and may include a reading system 32 to “read” identifying information about the data storage media. In the event of a failure or other unavailability of the first accessor 18, or its gripper 20, etc., the second accessor 28 may perform some or all of the functions of the first accessor 18. The two accessors 18, 28 may share one or more mechanical paths or they may comprise completely independent mechanical paths. In one example, the accessors 18, 28 may have a common horizontal rail with independent vertical rails. The first accessor 18 and the second accessor 28 are described as first and second for descriptive purposes only and this description is not meant to limit either accessor to an association with either the left hand service bay 13, or the right hand service bay 14.

In the exemplary library, first accessor 18 and second accessor 28 move their grippers in at least two directions, called the horizontal “X” direction and vertical “Y” direction, to retrieve and grip, or to deliver and release the data storage media at the storage shelves 16 and to load and unload the data storage media at the data storage drives 15.

The exemplary library 10 receives commands from one or more host systems 40, 41 or 42. The host systems, such as host servers, communicate with the library directly, e.g., on path 80, through one or more control ports (not shown), or through one or more data storage drives 15 on paths 81, 82, providing commands to access particular data storage media and move the media, for example, between the storage shelves 16 and the data storage drives 15. The commands are typically logical commands identifying the media and/or logical locations for accessing the media. The terms “commands” and “work requests” are used interchangeably herein to refer to such communications from the host system 40, 41 or 42 to the library 10 as are intended to result in accessing particular data storage media within the library 10.

The exemplary library is controlled by a distributed control system receiving the logical commands from hosts, determining the required actions, and converting the actions to physical movements of first accessor 18 and/or second accessor 28.

In the exemplary library, the distributed control system comprises a plurality of processor nodes, each having one or more processors. In one example of a distributed control system, a communication processor node 50 may be located in a storage frame 11. The communication processor node provides a communication link for receiving the host commands, either directly or through the drives 15, via at least one external interface, e.g., coupled to line 80.

The communication processor node 50 may additionally provide a communication link 70 for communicating with the data storage drives 15. The communication processor node 50 may be located in the frame 11, close to the data storage drives 15. Additionally, in an example of a distributed processor system, one or more additional work processor nodes are provided, which may comprise, e.g., a work processor node 52 that may be located at first accessor 18, and that is coupled to the communication processor node 50 via a network 60, 157. Each work processor node may respond to received commands that are broadcast to the work processor nodes from any communication processor node, and the work processor nodes may also direct the operation of the accessors, providing move commands. An XY processor node 55 may be provided and may be located at an XY system of first accessor 18. The XY processor node 55 is coupled to the network 60, 157, and is responsive to the move commands, operating the XY system to position the gripper 20.

Also, an operator panel processor node 59 may be provided at the optional operator panel 23 for providing an interface for communicating between the operator panel and the communication processor node 50, the work processor nodes 52, 252, and the XY processor nodes 55, 255.

A network, for example comprising a common bus 60, is provided, coupling the various processor nodes. The network may comprise a robust wiring network, such as the commercially available CAN (Controller Area Network) bus system, which is a multi-drop network, having a standard access protocol and wiring standards, for example, as defined by CiA, the CAN in Automation Association, Am Weich Selgarten 26, D-91058 Erlangen, Germany. Other networks, such as Ethernet, or a wireless network system, such as RF or infrared, may be employed in the library as is known to those of skill in the art. In addition, multiple independent networks may also be used to couple the various processor nodes.

The communication processor node 50 is coupled to each of the data storage drives 15 of a storage frame 11, via lines 70, communicating with the drives and with host systems 40, 41 and 42. Alternatively, the host systems may be directly coupled to the communication processor node 50, at input 80 for example, or to control port devices (not shown) which connect the library to the host system(s) with a library interface similar to the drive/library interface. As is known to those of skill in the art, various communication arrangements may be employed for communication with the hosts and with the data storage drives. In the example of FIG. 3, host connections 80 and 81 are SCSI busses. Bus 82 comprises an example of a Fibre Channel bus which is a high speed serial data interface, allowing transmission over greater distances than the SCSI bus systems.

The data storage drives 15 may be in close proximity to the communication processor node 50, and may employ a short distance communication scheme, such as SCSI, or a serial connection, such as RS-422. The data storage drives 15 are thus individually coupled to the communication processor node 50 by means of lines 70. Alternatively, the data storage drives 15 may be coupled to the communication processor node 50 through one or more networks, such as a common bus network.

Additional storage frames 11 may be provided and each is coupled to the adjacent storage frame. Any of the storage frames 11 may comprise communication processor nodes 50, storage shelves 16, data storage drives 15, and networks 60.

Further, as described above, the automated data storage library 10 may comprise a plurality of accessors. A second accessor 28, for example, is shown in a right hand service bay 14 of FIG. 3. The second accessor 28 may comprise a gripper 30 for accessing the data storage media, and an XY system 255 for moving the second accessor 28. The second accessor 28 may run on the same horizontal mechanical path as first accessor 18, or on an adjacent path. The exemplary control system additionally comprises an extension network 200 forming a network coupled to network 60 of the storage frame(s) 11 and to the network 157 of left hand service bay 13.

In FIG. 3 and the accompanying description, the first and second accessors are associated with the left hand service bay 13 and the right hand service bay 14 respectively. This is for illustrative purposes and there may not be an actual association. In addition, network 157 may not be associated with the left hand service bay 13 and network 200 may not be associated with the right hand service bay 14. Depending on the design of the library, it may not be necessary to have a left hand service bay 13 and/or a right hand service bay 14.

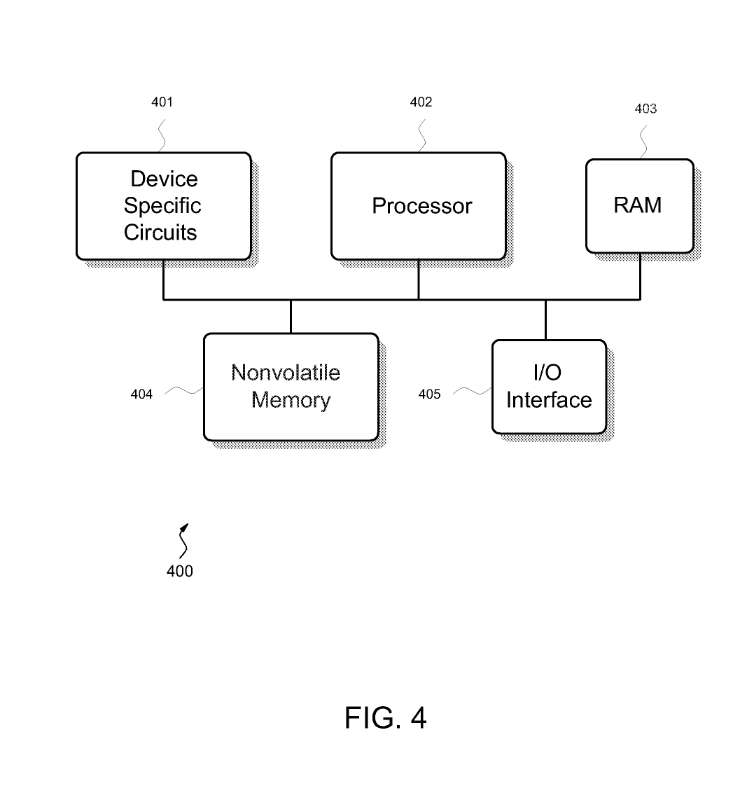

An automated data storage library 10 typically comprises one or more controllers to direct the operation of the automated data storage library. Host computers and data storage drives typically comprise similar controllers. A controller may take many different forms and may comprise, for example but not limited to, an embedded system, a distributed control system, a personal computer, or a workstation. Essentially, the term “controller” as used herein is intended in its broadest sense as a device that contains at least one processor, as such term is defined herein. FIG. 4 shows a typical controller 400 with a processor 402, RAM (Random Access Memory) 403, nonvolatile memory 404, device specific circuits 401, and I/O interface 405. Alternatively, the RAM 403 and/or nonvolatile memory 404 may be contained in the processor 402 as could the device specific circuits 401 and I/O interface 405. The processor 402 may comprise, for example, an off-the-shelf microprocessor, custom processor, FPGA (Field Programmable Gate Array), ASIC (Application Specific Integrated Circuit), discrete logic, or the like. The RAM (Random Access Memory) 403 is typically used to hold variable data, stack data, executable instructions, and the like. The nonvolatile memory 404 may comprise any type of nonvolatile memory such as, but not limited to, EEPROM (Electrically Erasable Programmable Read Only Memory), flash PROM (Programmable Read Only Memory), battery backup RAM, and hard disk drives. The nonvolatile memory 404 is typically used to hold the executable firmware and any nonvolatile data. The I/O interface 405 comprises a communication interface that allows the processor 402 to communicate with devices external to the controller. Examples may comprise, but are not limited to, serial interfaces such as RS-232, USB (Universal Serial Bus) or SCSI (Small Computer Systems Interface). The device specific circuits 401 provide additional hardware to enable the controller 400 to perform unique functions such as, but not limited to, motor control of a cartridge gripper. The device specific circuits 401 may comprise electronics that provide, by way of example but not limitation, Pulse Width Modulation (PWM) control, Analog to Digital Conversion (ADC), Digital to Analog Conversion (DAC), etc. In addition, all or part of the device specific circuits 401 may reside outside the controller 400.

While the automated data storage library 10 is described as employing a distributed control system, the present invention may be implemented in various automated data storage libraries regardless of control configuration, such as, but not limited to, an automated data storage library having one or more library controllers that are not distributed. A library controller may comprise one or more dedicated controllers of a prior art library. For example, there may be a primary controller and a backup controller. In addition, a library controller may comprise one or more processor nodes of a distributed control system. For example, communication processor node 50 (FIG. 3) may comprise the library controller while the other processor nodes (if present) may assist the library controller and/or may provide backup or redundant functionality. In another example, communication processor node 50 and work processor node 52 may work cooperatively to comprise the library controller while the other processor nodes (if present) may assist the library controller and/or may provide backup or redundant functionality. Still further, all of the processor nodes may comprise the library controller. Herein, library controller may comprise a single processor or controller or it may comprise multiple processors or controllers.

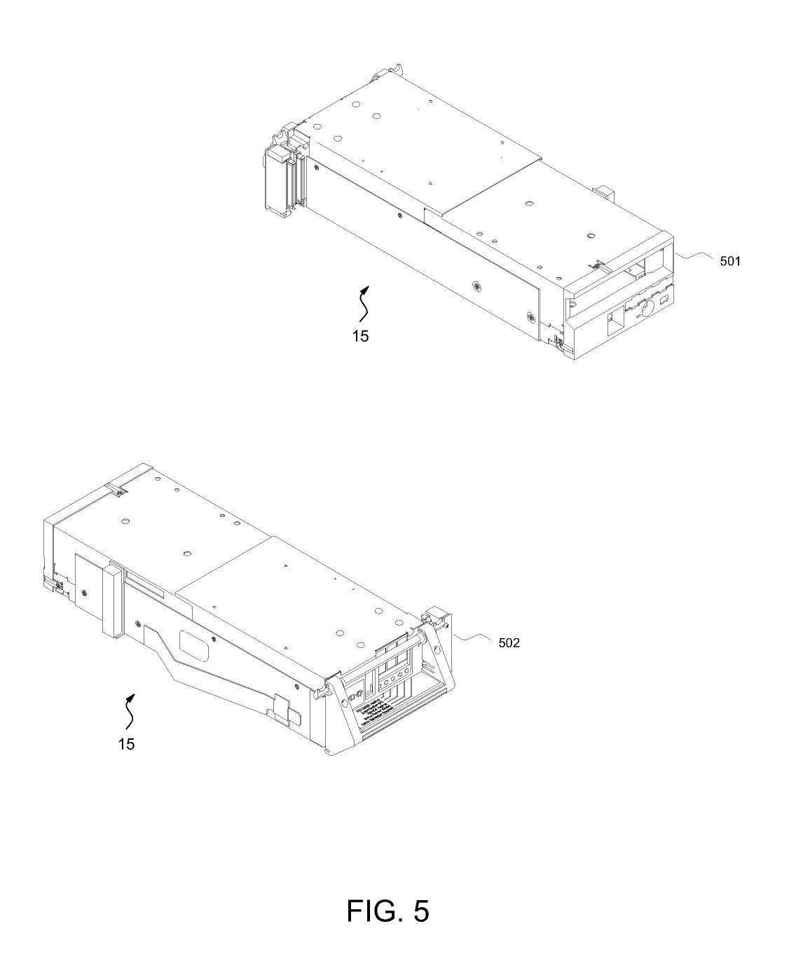

FIG. 5 illustrates an embodiment of the front 501 and rear 502 of a data storage drive 15. In the example of FIG. 5, the data storage drive 15 comprises a hot-swap drive canister. This is only an example and is not meant to limit the invention to hot-swap drive canisters. In fact, any configuration of data storage drive may be used whether or not it comprises a hot-swap canister.

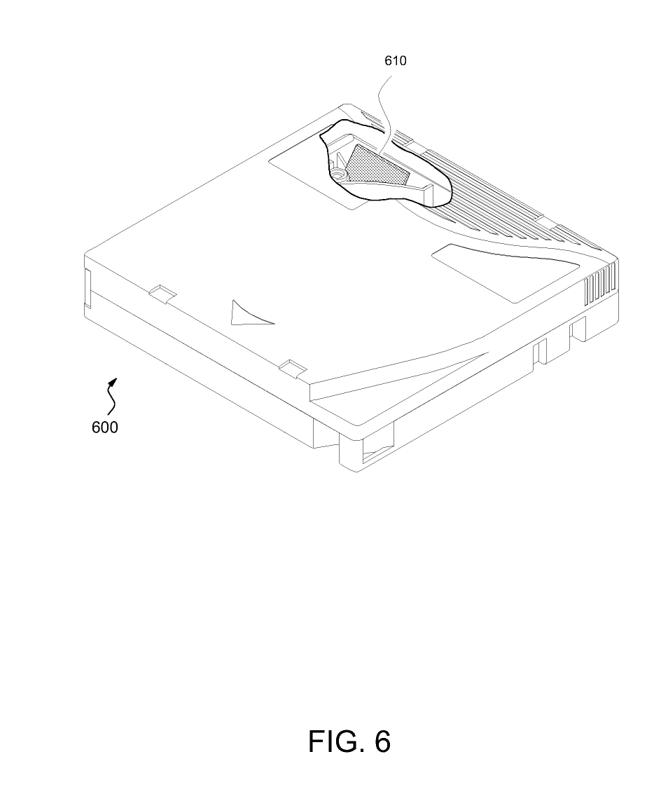

FIG. 6 illustrates an embodiment of a data storage cartridge 600 with a cartridge memory 610 shown in a cutaway portion of the Figure. This is only an example and is not meant to limit the invention to cartridge memories. In fact, any configuration of data storage cartridge may be used whether or not it comprises a cartridge memory.

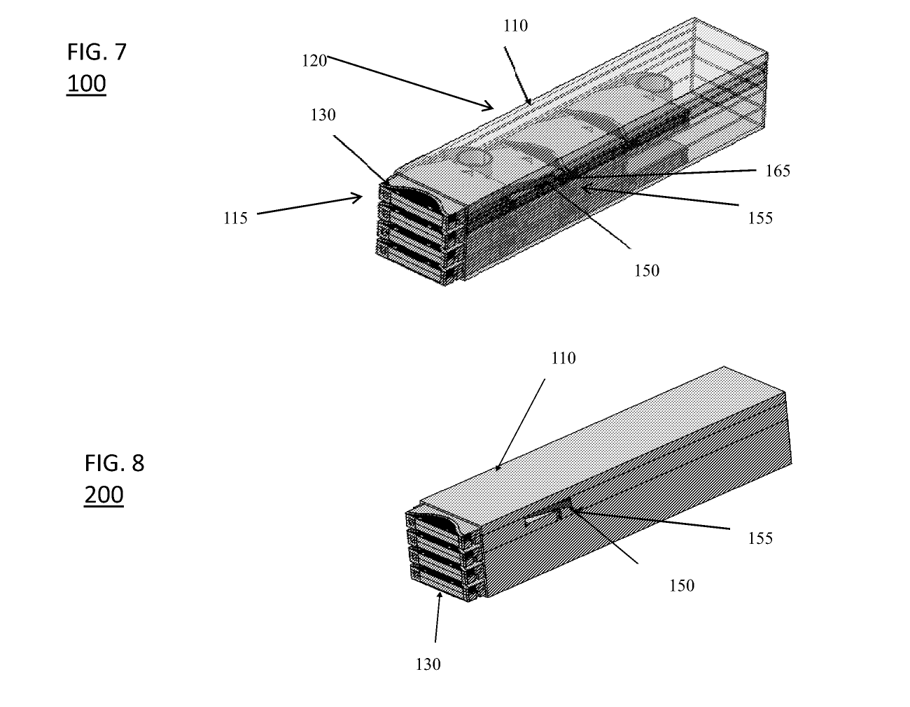

FIG. 7 illustrates a perspective view of one embodiment of a magazine 100 in accordance with one aspect of the invention. Magazine 100 includes a housing 110 defining an interior space 115. A plurality of storage slots 120 is disposed within the housing. Storage slots 120 are, in one embodiment, configured for holding a plurality of cartridges 130. Additionally, magazine 100 further includes at least one cartridge blocker 150. The cartridge blocker 150 includes an external portion 155 outside of the interior space 115 and an internal portion 165 within the interior space 115. The cartridge blocker 150 alternates between an open position and a closed position, wherein the open position provides access to at least one of the storage slots 120, and wherein the closed position substantially prevents access to at least one of the storage slots 120. Access to a storage slot may include the ability to remove a cartridge from a storage slot, the ability to place a cartridge into a storage slot, or combinations thereof. In one embodiment, the cartridge blocker is biased with a biasing member, such as a spring, toward the open position. In one embodiment, the cartridge blocker is biased with a biasing member, such as a spring, toward the closed position. In other embodiments, the cartridge blocker 150 is positioned with a locking member, such as a protrusion. FIG. 8 illustrates the exterior of FIG. 7. In this example, the storage slots from top to bottom are considered to be in parallel. The storage slots from front to back, in one particular row, are considered to be in series. In one embodiment, storage slots that are arranged in series do not have a permanent physical barrier between them. In another embodiment, storage slots that are arranged in parallel have a physical barrier between adjacent storage slots. The physical barrier is used to prevent a cartridge from inadvertently passing from one slot to another slot. In one embodiment, the physical barrier can be moved or removed. In another embodiment, the physical barrier is maintained by a spring. In another embodiment, the physical barrier is maintained by a blocker. In another embodiment the physical barrier is fixed.

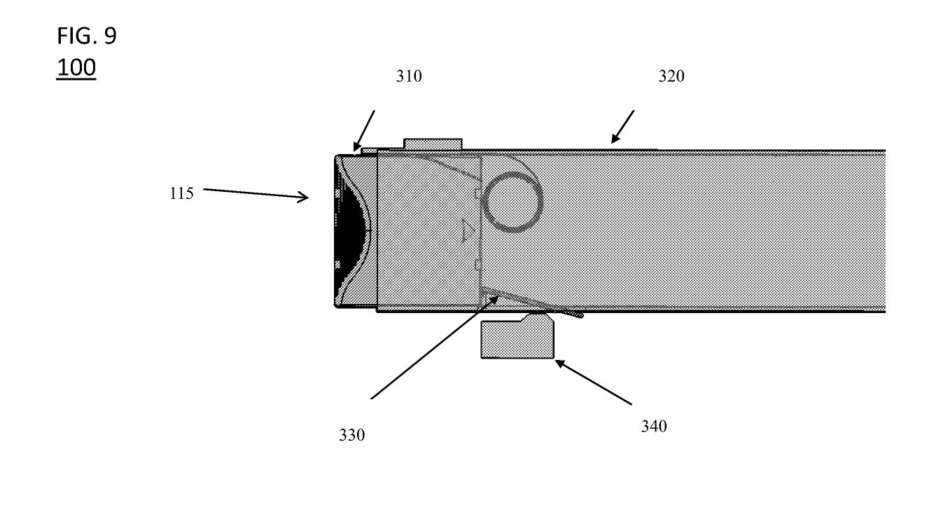

FIG. 9 illustrates a top view of the magazine 100 in accordance with one aspect of the invention. As seen in FIG. 9, magazine 100 includes a tape cartridge 310 entering the magazine, but prevented from entering a storage slot 320 by the cartridge blocker 330. Cartridge blocker 330 is deployed in a closed configuration. Library frame member 340 is on one side of the exterior portion of the cartridge blocker and closer to the entrance of the magazine than to the side opposing the entrance. When magazine 100 is inserted into the library, or removed from the library, the library frame member 340 actuates the cartridge blocker 330 to either prevent insertion of additional cartridges into the magazine (when the magazine is partially and/or fully removed from the library) or allow insertion of additional cartridges into the magazine (when the magazine is fully inserted in the library).

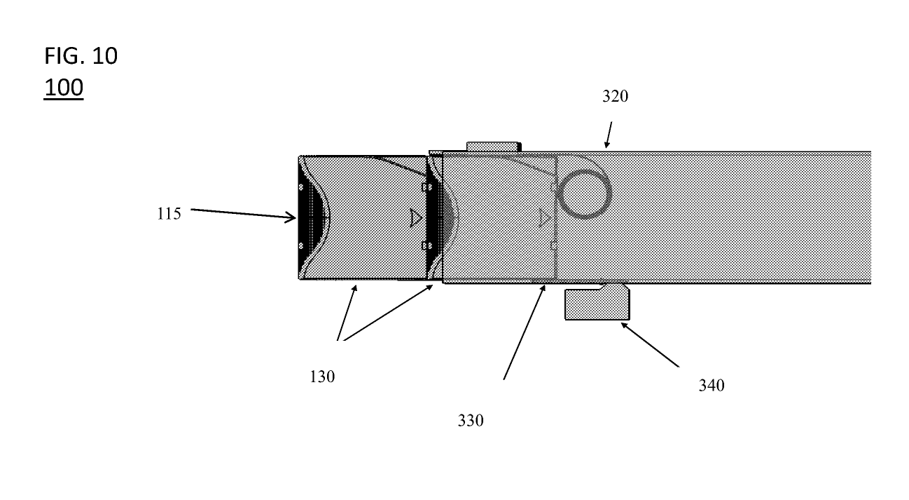

FIG. 10 illustrates a top view of magazine 100 in accordance with another aspect of the invention. FIG. 10 illustrates the cartridge blocker in an open position, allowing the cartridge to enter a storage slot.

In one embodiment, the invention includes a magazine including a housing defining an interior space and an exterior space with a plurality of storage slots disposed within the housing. In one embodiment, the magazine includes a number D of storage slots arranged in series, wherein D≧1 and wherein the storage slots include a number H of storage slots arranged in parallel wherein H≧1. In one embodiment, the parallel storage slots are above or below each other (FIG. 7). In another embodiment, the parallel storage slots are to one side or to the other of each other (not shown). In another embodiment, the parallel storage slots are both side by side, and above or below each other (not shown). In one embodiment, the magazine is a tape cartridge magazine.

The magazine further includes at least one cartridge blocker including an external portion outside of the interior space and the cartridge blocker including an internal portion within the interior space. In one embodiment, the cartridge blocker extends through the housing. The cartridge blocker alternates between an open position and a closed position, wherein the open position provides access to at least one of the storage slots, and wherein the closed position substantially prevents access to at least one of the storage slots. In one embodiment, the cartridge blocker is positioned between the Dᵢ and Dᵢ₊₁ storage slot. In one embodiment, the cartridge blocker is positioned between the first and second storage slot. In yet another embodiment, the cartridge blocker is positioned between the first slot and an entrance to the magazine. In one embodiment, the cartridge blocker is positioned to allow removal of Dᵢ cartridges from the magazine when the cartridge blocker is in the closed position. In one embodiment, the cartridge blocker is positioned to allow insertion of Dᵢ cartridges into the magazine when the cartridge blocker is in the closed position.

In one embodiment, the magazine includes at least one cartridge disposed in at least one storage slot. In one embodiment, the cartridge blocker alternates between the open position and closed position responsive to actuation by a library frame member. In such embodiments, removal of the magazine from a library frame results in the library frame member translating the cartridge blocker from an open to a closed position, and wherein placing or receiving the magazine in the library frame translates the cartridge blocker from the closed position to the open position.

In one embodiment, the invention includes a tape library system. The tape library system includes a library frame including one or more library frame members, and one or more magazines configured to be supported by the library frame member(s). The magazine includes a housing defining an interior space and an exterior space with a plurality of storage slots disposed within the housing. In one embodiment, the magazine includes a number D of storage slots arranged in series, wherein D≧1 and wherein the storage slots include a number H of storage slots arranged in parallel wherein H≧1. In one embodiment, the parallel storage slots are above or below each other (FIG. 7). In another embodiment, the parallel storage slots are to one side or to the other of each other (not shown). In another embodiment, the parallel storage slots are both side by side, and above or below each other (not shown). In one embodiment, the magazine is a tape cartridge magazine. The magazine further includes at least one cartridge blocker which may include an external portion outside of the interior space and the cartridge blocker may include an internal portion within the interior space. In one embodiment, the cartridge blocker extends through the housing. The cartridge blocker alternates between an open position and a closed position, wherein the open position provides access to at least one of the storage slots, and wherein the closed position substantially prevents access to at least one of the storage slots. In one embodiment, the cartridge blocker is positioned between the Dᵢ and Dᵢ₊₁ storage slot, wherein Dᵢ₊₁<=D. In one embodiment, the cartridge blocker is positioned between the first and second storage slot. In yet another embodiment, the cartridge blocker is positioned between the first slot and an entrance to the magazine. In one embodiment, the cartridge blocker is positioned to allow removal of Dᵢ cartridges from the magazine when the cartridge blocker is in the closed position. In one embodiment, the cartridge blocker is positioned to allow insertion of Dᵢ cartridges into the magazine when the cartridge blocker is in the closed position.

In one embodiment, the magazine includes at least one cartridge disposed in at least one storage slot. In one embodiment, the cartridge blocker alternates between the open position and closed position responsive to actuation by a library frame member. In such embodiments, partial and/or complete removal of the magazine from a library frame results in the library frame member translating the cartridge blocker from an open to a closed position, and wherein placing or receiving the magazine in the library frame translates the cartridge blocker from the closed position to the open position.

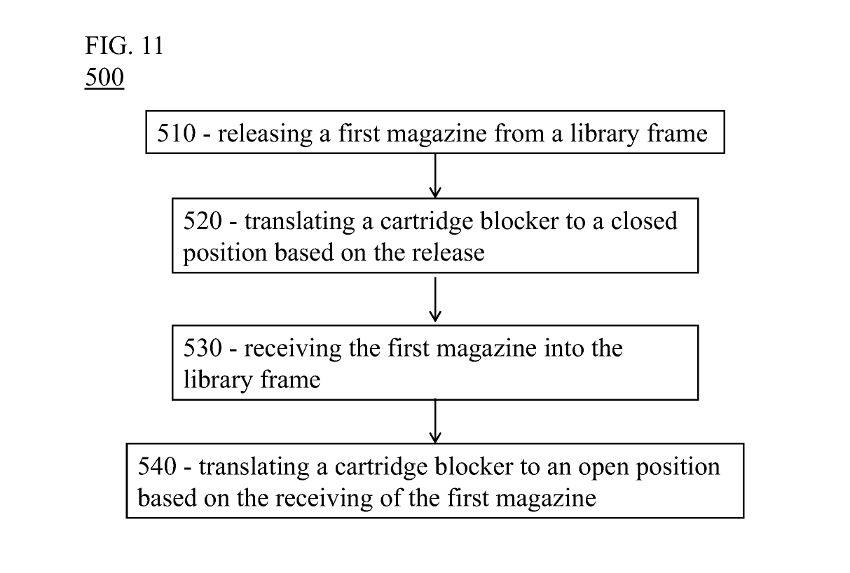

FIG. 11 illustrates a flowchart of a method 500 for storing cartridges, in accordance with one aspect of the invention. Method 500 begins by removing, at step 510, a first magazine from a library frame. The first magazine can be removed by an operator or by a mechanical grabber. At step 520, the cartridge blocker is translated to a closed position based on the removal. In one embodiment, the translation is responsive to a cam-type actuator. In one embodiment, the removal is a partial removal to allow access to a subset of the storage slots in the magazine. This may be desired to allow a magazine to provide storage slots for support of an I/O station, for example. An I/O station is used to provide access to cartridge slots without opening a library door, or when there is no library door. The partial removal may restrict access to some of the storage slots in the magazine while the slot blocker may further restrict access to additional storage slots. An I/O station is placed or received when it is placed in the position it was at prior to the removal or partial removal. At step 530, the first magazine or another magazine is inserted into the library frame, and at step 540, the cartridge blocker is translated to an open position based on the receiving of the magazine. In one embodiment, the translation is responsive to a cam-type actuator. In one embodiment, steps 510-540 comprise a first magazine. In another embodiment steps 510 and 520 comprise a first magazine and steps 530 and 540 comprise a second magazine.

For example, an exemplary magazine stores 20 cartridges in a 4×5 array, necessitating a swap area for temporary storage of removed cartridges while accessing a deep cartridge. In this example, D=5, H=4, and a swap area is required for 4 cartridges, because 4 cartridges would have to be moved out of the way to gain access to the fifth (and last) cartridge in one of the parallel deep slots. Certain slots may be designated as being dedicated for the swap area. When the magazine is removed, an interlock would prevent cartridges from being inserted into the designated swap area. For example, a pin may block the slot when the magazine is removed.

Alternatively, in one embodiment, the cartridge blocker allows the magazine to be full (i.e. 20 cartridges stored in a 20 cartridge magazine), but the user may only be able to access 16 cartridges (20 total cartridges minus 4 swap area cartridges) while the magazine is removed from the library. This may be desired, for example, if the swap area is temporarily full when the user removes the magazine.

In one embodiment, the cartridge blocker is used to restrict the insertion of cartridges for purposes of providing the equivalent of I/O station slots. For example, in the 20 cartridge magazine, it may be desired to have 3 cartridges for I/O station access. In this embodiment, the tape blocker(s) would be positioned to allow 3 cartridges to be inserted when the magazine is partially or fully out of the library. In this embodiment, the remaining cartridges in the tape blocker slot(s) may be used as a swap area, may be used as normal storage slots, may be used as special purpose slots (not I/O, storage, or swap slots), or combinations thereof when the magazine is present in the library.

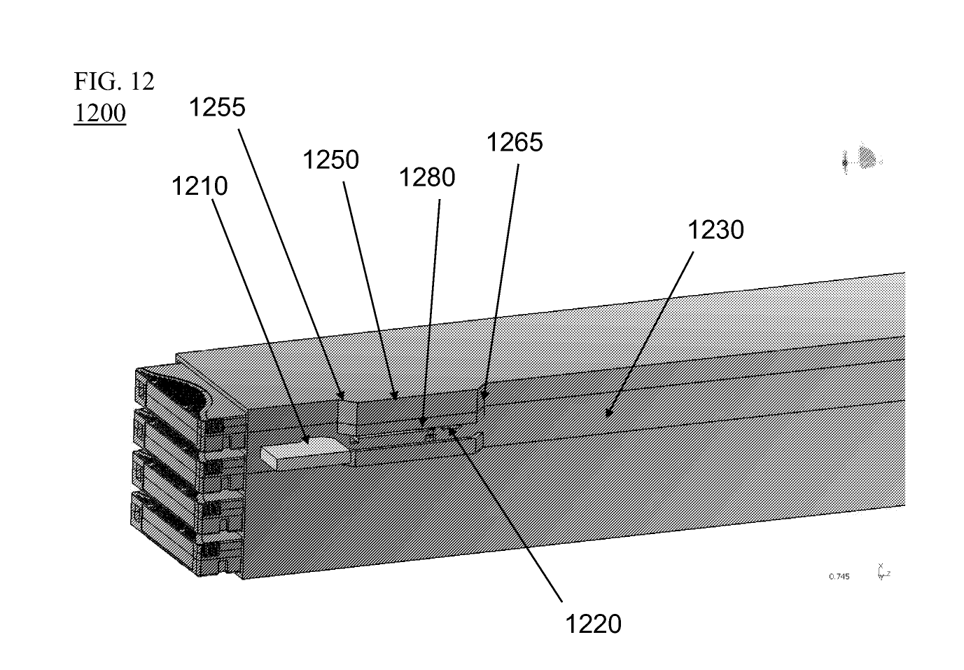

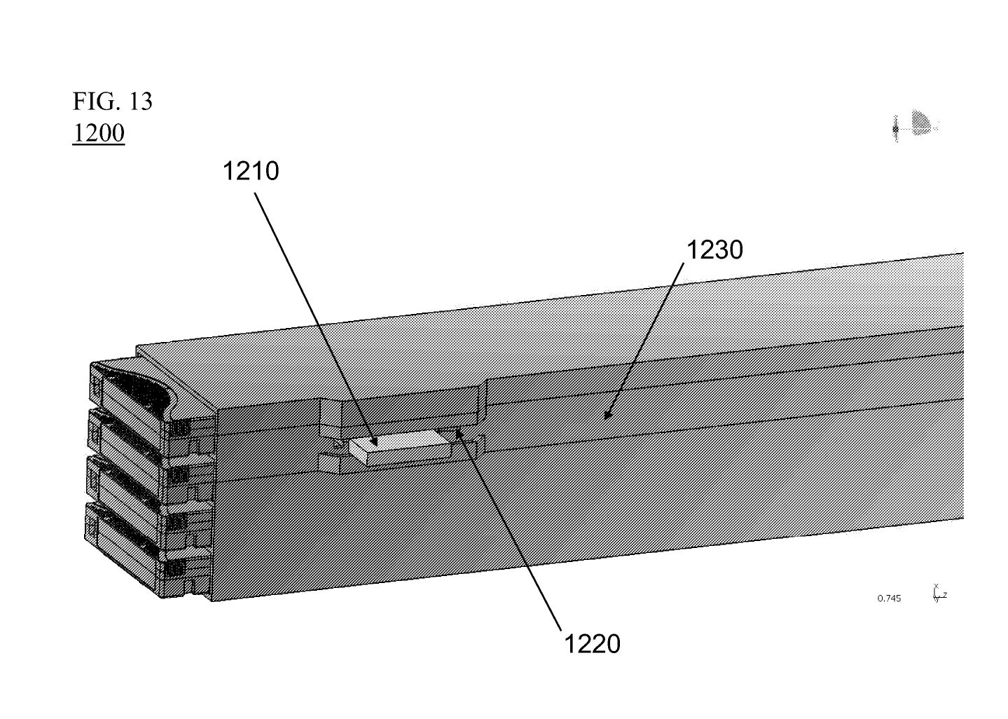

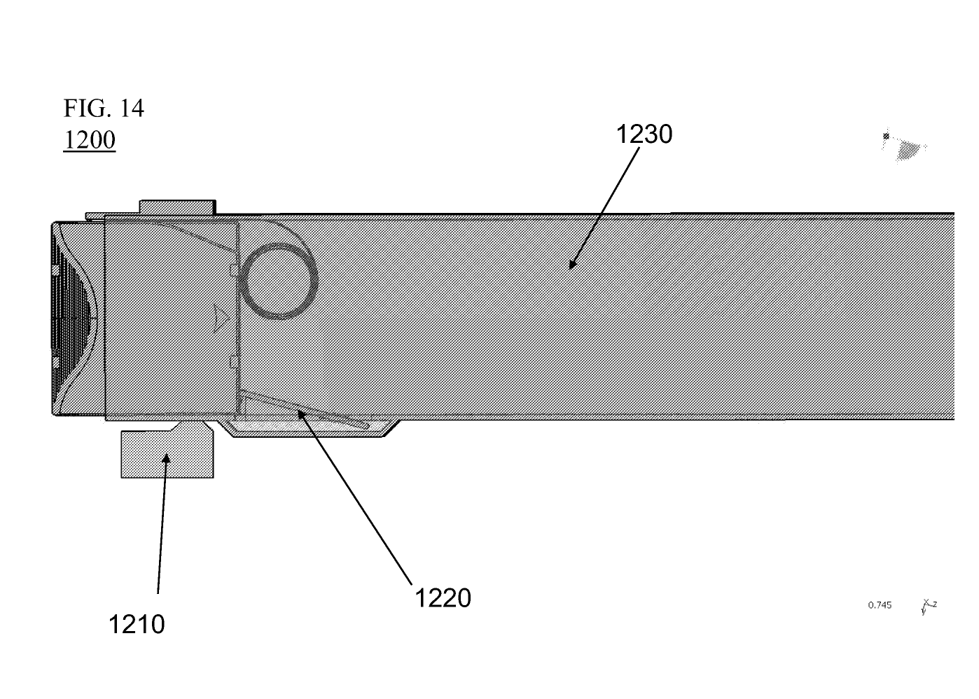

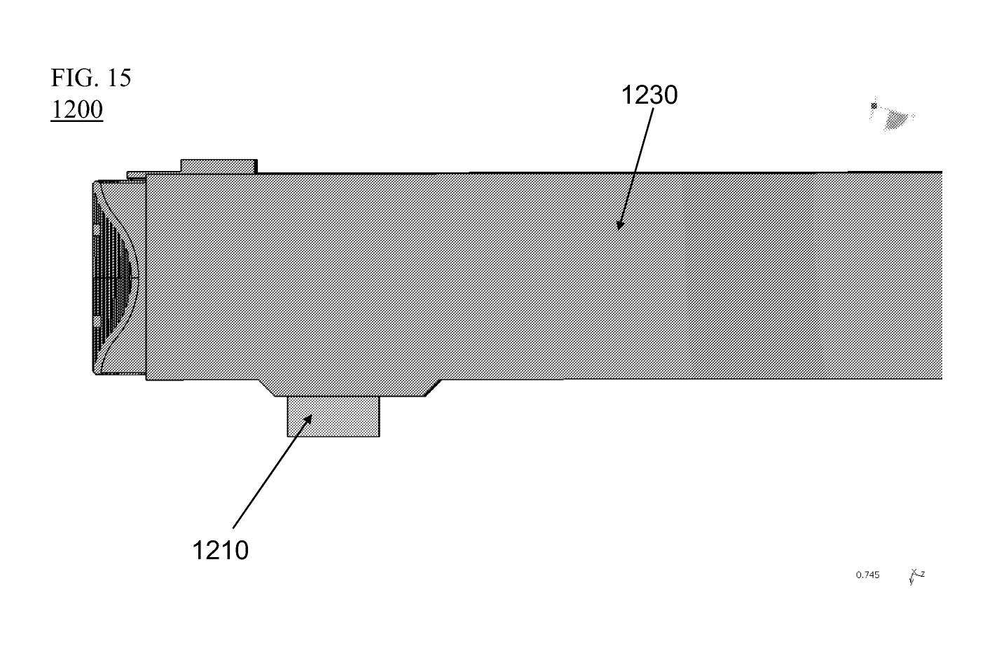

FIGS. 12-15 illustrates various views of another embodiment of a magazine in accordance with another aspect of the invention. FIG. 12 is a side isometric view of the magazine 1200. Frame member 1210 is illustrated with deep slots 1230 contained within the magazine 1200. Cartridge blocker 1220 is also illustrated. In FIGS. 12-15 the cartridge blocker 1220 is contained entirely in the interior space of the magazine, as compared to FIGS. 7-12 which illustrate a portion of the cartridge blocker extending into the exterior space of the magazine. In the example of FIGS. 12-15, the frame member enters the interior space of the magazine whereas in the example of FIGS. 7-12, the frame member does not enter the interior space of the magazine. In the embodiment illustrated in FIGS. 12-15, the cartridge blocker 1220 is contained in the interior space of magazine 1200. The frame member 1210 extends from the frame, and enters a hole or slot in the magazine to actuate the slot blocker 1220 (to affect access to the deep slots 1230). In one embodiment, the frame includes a fixed frame member. In one embodiment, the frame includes a frame member configured to rotate about a hinge to enter a hole in the magazine such that a portion of the cartridge blocker occupies a portion of the space defined by an inner wall of the magazine and operates to restrict access to any deep slots on a side of the cartridge blocker that opposes the side nearest the entrance to the magazine. In one embodiment, the frame includes a spring biased frame member configured to rotate about a hinge to enter a hole in the magazine such that a portion of the cartridge blocker occupies a portion of the space defined by an inner wall of the magazine and operates to restrict access to any deep slots on a side of the cartridge blocker that opposes the side nearest the entrance to the magazine. In one embodiment, the cartridge blocker is actuated by a cam configured to move in response to a magazine entering or existing the support frame.

In one embodiment, such as illustrated in FIG. 12, the magazine includes a ledge portion 1250 including ramp 1255 and ramp 1265. Ledge portion 1250 interacts with the cartridge blocker 1220 to translate the cartridge blocker 1220 between the open position and closed position. In one embodiment, the frame member 1210 passes through a gap 1280 in the ledge portion 1250 to actuate the cartridge blocker 1220.

Alternatively, the cartridge blocker may be designed to allow the magazine to be full, but the user may only be able to access the first n cartridges in the magazine (where n<D) while it is removed from the library (not shown). This may be desired if the remaining cartridges are not necessarily used as a swap area.

As will be recognized, use of the devices and methods herein may make it difficult for a user to place too many cartridges in a removable magazine while the magazine is partially and/or fully removed from a library. For example, if the magazine has had a cartridge removed while in the library. In other words, if a cartridge is removed from a magazine for accessing its contents or other purposes, and a user then removes the magazine from the library prior to return of the removed cartridge, the cartridge blocker will reduce the ability of the user to place additional cartridges into the magazine. In addition, use of the devices and methods herein may make it difficult for a user to have access to certain cartridges in a removable magazine while the magazine is partially and/or fully removed from a library. For example, the blocker can be used to restrict access (insert and/or removal of cartridges) to certain cartridge slots within a magazine.

While the figures and description of this invention have discussed the frame member in particular detail, it should be noted that other variations of the frame member may be employed, for actuating a blocker, without deviating from the scope of this invention. For example, the frame member may reside in the back of the magazine slot, in the front of the magazine slot, above the magazine slot, below the magazine slot, on the side of the magazine slot, etc. The frame member may comprise a protrusion for entering the magazine, an indentation for receiving a protrusion from the magazine, a slot, hole, or any other defining characteristic of the frame or slot that holds the magazine. In addition, the frame member may comprise an electrically or mechanically operated device that only actuates the blocker at certain times or under certain conditions when activated by an electrical signal or a mechanical linkage. For example, the frame member may be electrically or mechanically controlled to only actuate the blocker when a library door is open. In this example, the blocker may be actuated when a magazine is removed and replaced, or there may not be a magazine at all. Herein, frame member comprises any characteristic of the magazine slot that may be used to actuate a blocker.

While the figures and description of this invention have discussed the magazine in particular detail, it should be noted that other variations of the magazine may be employed without deviating from the scope of this invention. Indeed, the magazine may comprise any array of cartridge slots (x slots high, y slots across, z slots deep) in any orientation. For example, the magazine may comprise a 1, 5, 2 array where the magazine is 1 slot high, 5 slots wide, and 2 slots deep. In the example of FIG. 7, the magazine array is arranged as 4, 1, 5. In addition, the magazine may comprise fixed slots of which none are actually removable from the library. For example, the magazine may comprise a wall of deep slot storage slots (storage shelves 16, on rear wall 19 of FIG. 2). In this example, the blocker may be actuated electrically or mechanically, as described above.

While the figures and description of this invention have discussed the blocker in particular detail, it should be noted that other variations of the blocker may be employed without deviating from the scope of this invention. The blocker has been described as being open when not in the blocking state, and closed when in the blocking state. This is for descriptive purposes only, and is not meant to limit the scope of the invention to something actually being opened or closed.

While the embodiments of the present invention disclosed herein are presently considered to be preferred embodiments, various changes and modifications can be made without departing from the spirit and scope of the present invention. The scope of the invention is indicated in the appended claims, and all changes that come within the meaning and range of equivalents are intended to be embraced therein.

We claim:

1. A magazine comprising:
a housing defining an interior space and an exterior space;
a plurality of storage slots disposed within the housing; and
at least one cartridge blocker, and wherein the cartridge blocker alternates between an open position and a closed position, wherein the open position provides access to at least one of the storage slots, and wherein the closed position substantially prevents access to at least one of the storage slots.

2. The magazine of claim 1 wherein the cartridge blocker alternates between the open position and closed position responsive to actuation by a library frame member.

3. The magazine of claim 2 wherein removal of the magazine from a library frame results in the library frame member translating the cartridge blocker from an open to a closed position, and wherein placing the magazine in the library frame translates the cartridge blocker from the closed position to the open position.

4. The magazine of claim 3 wherein removal of the magazine comprises partial removal of the magazine, and wherein placing the magazine comprises placing the magazine in the position prior to partial removal.

5. The magazine of claim 1 wherein the storage slots include a number D of storage slots arranged in series, wherein D≧1.

6. The magazine of claim 5 wherein the cartridge blocker is positioned between the Dᵢ and Dᵢ₊₁ storage slot, wherein Dᵢ₊₁<=D.

7. The magazine of claim 6 wherein the cartridge blocker is positioned to allow removal of Dᵢ cartridges from the magazine when the cartridge blocker is in the closed position.

8. The magazine of claim 5 wherein the storage slots include a number H of storage slots arranged in parallel wherein H≧1.

9. The magazine of claim 1 wherein the magazine is a tape cartridge magazine.

10. The magazine of claim 1 wherein the cartridge blocker includes an external portion outside of the interior space and the cartridge blocker further includes an internal portion within the interior space.

11. The magazine of claim 1 wherein the cartridge blocker is disposed within the interior space and translates between the open position and closed position responsive to a library frame member contacting the cartridge blocker in the interior space.

12. A tape library system comprising:
a library frame, the library frame including at least one magazine, at least one of the at least one magazine comprising:
a housing defining an interior space and an exterior space;
a plurality of storage slots disposed within the housing; and
at least one cartridge blocker, and wherein the cartridge blocker alternates between an open position and a closed position, wherein the open position provides access to at least one of the plurality of storage slots, and wherein the closed position substantially prevents access to at least one of the plurality of storage slots, wherein the cartridge blocker alternates between the open position and closed position responsive to actuation by a library frame member, and wherein removal of the one of the at least one magazine from the library frame results in the library frame member translating the cartridge blocker from the open to the closed position, and wherein placing the one of the at least one magazine in the library frame translates the cartridge blocker from the closed position to the open position.

13. The system of claim 12 wherein removal of the one of the at least one magazine comprises partial removal of the magazine, and wherein placing the one of the at least one magazine comprises placing the magazine in the position prior to partial removal.

14. The system of claim 13 wherein the magazines include a number D of storage slots arranged in series, wherein D≧1.

15. The system of claim 13 wherein the cartridge blocker is positioned between the Dᵢ and Dᵢ₊₁ storage slot, wherein Dᵢ₊₁<=D.

16. The system of claim 13 wherein the at least one magazine includes a number H of storage slots arranged in parallel wherein H≧1

17. The system of claim 13 wherein the cartridge blocker includes an external portion outside of the interior space, and wherein the cartridge blocker includes an internal portion within the interior space.

18. The system of claim 13 wherein the cartridge blocker is disposed within the interior space and translates between the open position and closed position responsive to a library frame member contacting the cartridge blocker in the interior space.

19. A method for storing cartridges, the method comprising:
removing a first magazine from a library frame;
translating a cartridge blocker to a closed position based on the removal;
receiving the first magazine into the library frame; and
translating a cartridge blocker to an open position based on the receiving of the first magazine.

20. The method of claim 19, wherein the open position provides access to at least one of the storage slots, and wherein the closed position substantially prevents access to at least one of the storage slots.
